(19) United States
(12) Patent Application Publication
(10) Pub. No.: US 2026/0054591 A1
(43) Pub. Date: Feb. 26, 2026

(54) METHOD AND APPARATUS FOR ADJUSTING A CONTROL PILOT SIGNAL OF ELECTRIC VEHICLE SUPPLY EQUIPMENT

(71) Applicant: Enphase Energy, Inc., Petaluma, CA (US)

(72) Inventors: Vishal CHANDRASHEKAR, Petaluma, CA (US); Sreejakumar NAIR, Bangalore (IN)

(21) Appl. No.: 19/279,107

(22) Filed: Jul. 24, 2025

(30) Foreign Application Priority Data
Aug. 20, 2024 (IN) 202411062756

(51) Int. Cl. B60L 53/63; B60L 53/62

(52) U.S. Cl. CPC B60L 53/63; B60L 53/62

(57) ABSTRACT

A method and apparatus for adjusting a control pilot of an EVSE to enable off-grid utilization of the EVSE. The apparatus comprises a charging controller, coupled to a utility power grid, for measuring grid stability and creating at least one indicium of grid stability. A control pilot manipulator adjusts a duty cycle of the control pilot signal based on the at least one indicium of grid stability.

### RELATED APPLICATION

This application claims benefit to Indian Provisional Patent Application Serial Number 202411062756 filed 20 Aug. 2024 entitled “Method and Apparatus for Adjusting a Control Pilot Signal of Electric Vehicle Supply Equipment,” which is hereby incorporated herein by reference in its entirety.

### BACKGROUND

### Field

Embodiments of the present invention generally relate to electric vehicle supply equipment (EVSE) and, in particular, to a method and apparatus for adjusting a control pilot signal of an EVSE to enable operation without a power grid connection (i.e., off-grid operation) in order to ensure that a micro-grid that includes the EVSE does not collapse.

### Description of the Related Art

An EVSE is used to charge an electric vehicle (EV). Typically, an EVSE is connected to a power source through a load controller. The power source is typically the utility grid, but it may also be battery storage, solar power, wind power, fuel cell, etc. An EVSE connects to an EV via a cable and a connector, such as, for example, a J1772, NACS or Type 2 (IEC 62196) connector. The cable carries the AC power to charge the EV as well as various control signals.

The control signals include a control pilot signal comprising a 1 KHz square wave (+/−12volts) that has a modulated duty cycle. This signal is used to detect that an EV is connected to the EVSE, communicate the maximum allowable charging current and control charging from start and to finish. The EV forms the master controller which abides by protocol/standards. The EVSE pulse width modulates the control pilot signal to establish a specific duty cycle that represents the maximum power capability of the EVSE and the EV regulates demand to be under the, thus communicated, current. The control pilot duty cycle is measured by the EV's battery management unit, e.g., the OBC (on board charger), to set the amount of AC power the EV batteries will draw from the EVSE (i.e., set a maximum charging current the EV will draw). For example, as defined by the SAE J1772 standard, a 10% duty cycle establishes a maximum current of 6 Amps, while a 50% duty cycle sets a 30 Amp maximum. Consequently, the EV will not draw more current than the EVSE is able to supply such that damage to the EVSE is avoided.

In EVSE installations that are supplied with renewable energy, the EVSE is viewed as a load to the power system and is typically connected to the power sources (e.g., grid, solar, battery, etc.) via a load controller. The load controller generally comprises relays to control the supply of power to each load. The load controller is generally coupled to a system controller. In a conventional architecture, the system controller monitors the status of the grid. If the grid becomes unstable, the system controller informs the load controller that loads should be shed from the grid to stabilize the grid. This is especially important when the power system is not connected to the utility grid (i.e., operating off-grid as a microgrid). The amount of power usage in a microgrid must be strictly controlled to enable the grid to remain stable. Typically, when grid instability is detected or the system begins operating in an off-grid mode, the load controller disconnects the EVSE from the power system to ensure no power is consumed by the EVSE to charge an EV. Disconnecting the EVSE is intended to ensure charging is discontinued and the grid will return to a stable state.

Therefore, there is a need for an EVSE that may be used to charge an EV when the power system is operating in off-grid mode.

### SUMMARY

A method and apparatus for adjusting the control pilot signal of electric vehicle supply equipment (EVSE) is provided substantially as shown in and/or described in connection with at least one of the figures, as set forth more completely in the claims.

Various features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the various features of the present invention can be understood in detail, a particular description of the invention, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of power system comprising an EVSE in accordance with at least one embodiment of the invention;

FIG. 2 depicts a block diagram of an EVSE in accordance with an embodiment of the invention;

FIG. 3 depicts block diagram of an EVSE in accordance with an alternative embodiment of the invention;

FIG. 4 depicts a detailed block diagram of the EVSE of FIGS. 1 and 2 in accordance with at least one embodiment of the invention;

FIG. 5 depicts flow diagram of the operation of the EVSE in accordance with at least one embodiment of the invention; and

FIG. 6 depicts a solar powered carport for charging an EV in accordance with at least one embodiment of the invention.

### DETAILED DESCRIPTION

Embodiments of the present invention comprise a method and apparatus for adjusting a control pilot (CP) signal of electric vehicle supply equipment (EVSE) to enable EVSE off-grid operation. Various embodiments of the EVSE comprise a charging controller, a CP generator and a CP manipulator. The EVSE monitors the input AC power characteristics such as voltage, current and/or frequency, generates a traditional CP signal, manipulates the CP signal to form a modified signal that is applied to an EV. The AC power characteristics are indicative of the state of the grid (i.e., a measure of grid stability). The modified CP signal has a duty cycle that is established in response to the grid stability state. In this manner, as energy is available in varying quantities from a renewable source or sources while operating off-grid, the modified CP signal adapts to the available energy to maintain a stable grid, the EV manipulates the draw within a duration defined by the SAE J1772 standard. Consequently, an EV charging station can be created that does not require a utility grid connection, a load controller or battery storage. Embodiments of the EVSE may be connected directly to a renewable energy source such as, but not limited to, wind turbine(s) or solar panel(s).

In an alternative embodiment, the CP manipulator is a stand-alone device that is electrically connected between a traditional EVSE and an EV. The CP manipulator modifies the CP generated by the traditional EVSE to create a modified CP that automatically adjusts the duty cycle of the CP depending on the grid stability state.

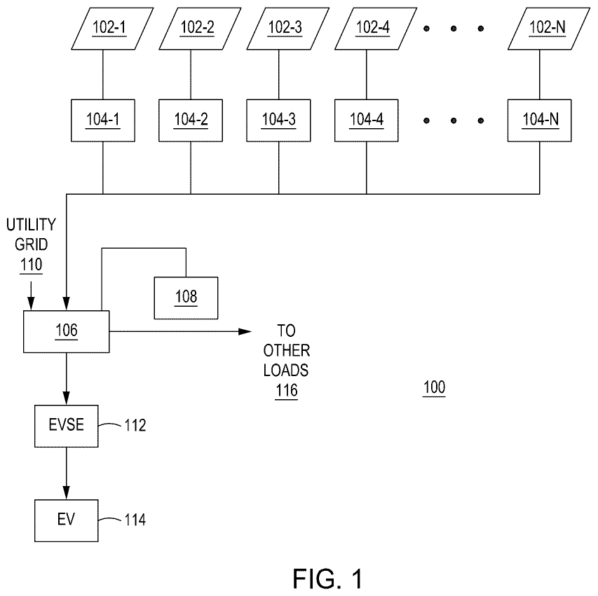

FIG. 1 depicts a block diagram of a renewable energy generation and storage system 100 comprising an EVSE 112 in accordance with at least one embodiment of the invention. The system 100 comprises a plurality of distributed generators 102 (e.g., solar panels 102-1, 102-2, 102-3, . . . 102-N coupled to micro inverters 104-1, 104-2, 104-3, . . . 104-4), storage 108 (e.g., batteries coupled to bidirectional inverters), and a service panel 106 through which the distributed generator 102 is coupled to the storage 108. In an alternative embodiment, the distributed generators 102 may comprise string inverters. The service panel 106 is also coupled to a plurality of loads 116 and the EVSE 112. The loads 116, in a residential application, may comprise washer, dryer, refrigerator, air conditioner, hot water heater, heat pump, and/or any other electricity consuming device in the household. The loads 116, in an industrial application, may comprise electric motors, heating systems, air conditioning systems, refrigerators, freezers, and/or any other electricity consuming device generally used in an industrial setting. The service panel 106 may also be coupled to the utility power grid 110, such that, energy may be consumed from the grid 110 or sourced to the grid 110, as necessary. As shall be described below, embodiments of the present invention facilitate charging an electric vehicle (EV) 114 with the EVSE 112 when the system 100 is operating in an off-grid mode (i.e., disconnected from the power grid 110) and controlling the amount of power consumed by the EV 114 in response to microgrid stability. The microgrid is defined as the renewable energy generation and storage system 100 when it is operating in an off-grid mode, where the distributed resources, storage, and loads form an electrical grid that is not connected to the utility power grid.

Although FIG. 1 depicts a distributed generator 102 having a single solar panel coupled to a single inverter (i.e., micro-inverter), this depiction is not meant to limit the scope of the claimed invention. For example, embodiments of the invention may also be used with distributed generators having a plurality or more solar panels coupled to one or more inventers. Alternatively, string inverters can be incorporated into this architecture. Furthermore, distributed generators may include other forms of energy generation such as wind turbines arranged on a so-called “wind farm.” Similarly, energy storage in a battery-based storage system is described as an example of the type of storage used in embodiments of the invention; however, other forms of energy storage may be used such as fly wheel(s), hot fluid tank(s), hydrogen storage system(s), pressurized gas storage system(s), pumped storage hydropower, fuel cells, or the like.

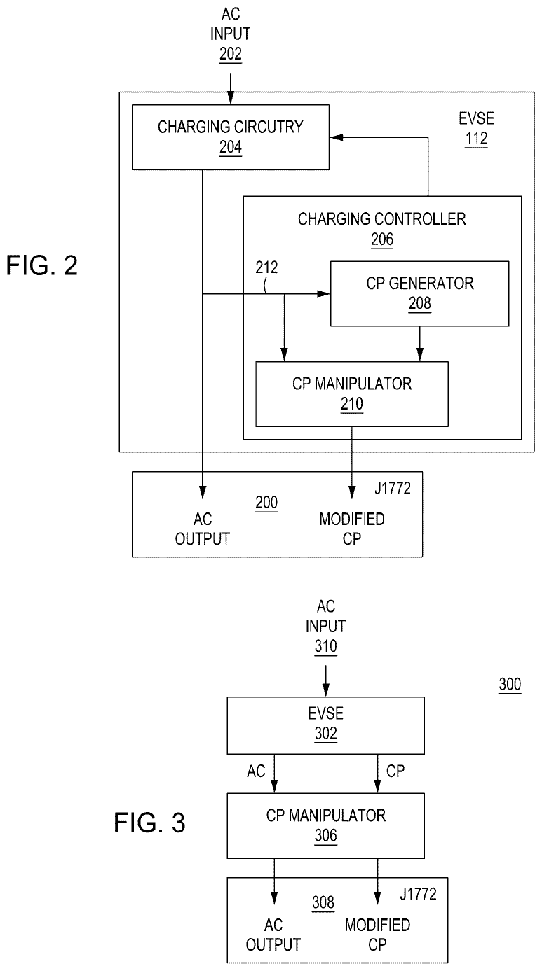

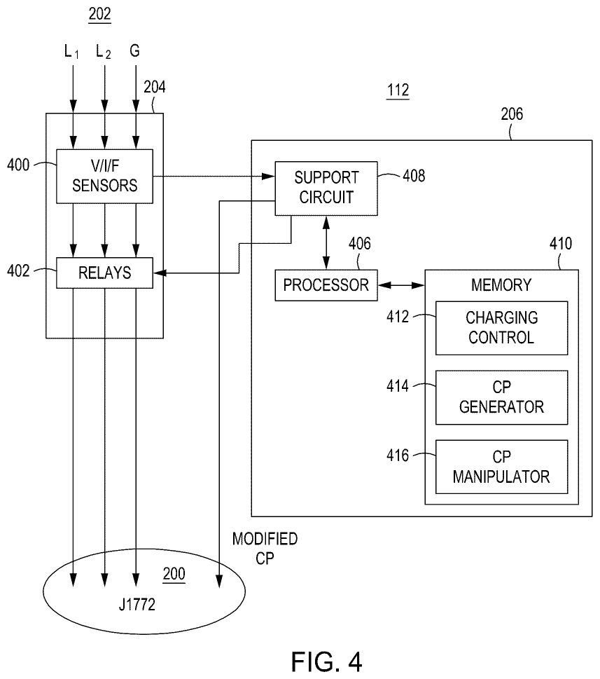

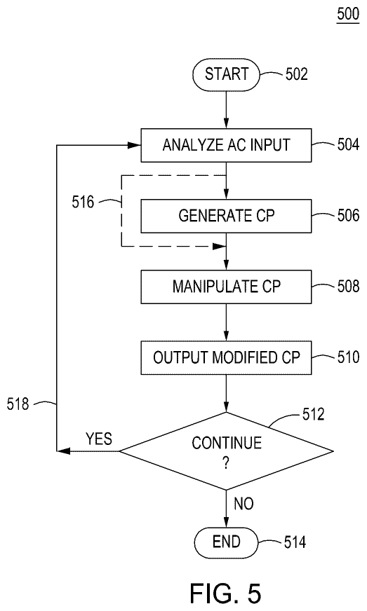

FIG. 2 depicts a block diagram of an EVSE 112 in accordance with an embodiment of the invention. The EVSE 112 receives an AC input 202 (AC power) from the service panel and output AC power to a J1772 connector 200 (or other similar connector). The EVSE 112 comprises charging circuitry 204 coupled to a charging controller 206. The charging controller 206 comprises a CP generator 208 and a CP manipulator 210. In some embodiments, the CP generator 208 and CP manipulator 210 may be a single device to directly generate the modified CP based on the measured grid stability. The charging controller 206 monitors at least one of the AC frequency, voltage and current to determine the grid stability, i.e., if the grid becomes overloaded, the frequency becomes lower than nominal (e.g., 50 Hz or 60 Hz). Details of the structure and operation of the EVSE are described with respect to FIGS. 4 and 5 below.

FIG. 3 depicts block diagram of an EVSE in accordance with an alternative embodiment of the invention. In this alternative embodiment, the CP manipulator 306 is a standalone component or device connected between a standard EVSE 302 and the J1772 connector 308. In this embodiment, the AC input 310 is coupled to the EVSE 302 and the output of the EVSE 302 is coupled to the CP manipulator 306. The EVSE may be hard wired to the CP manipulator 306, or the J1772 or other output connector may be plugged into a matching connector on the CP manipulator 306. The CP manipulator 306 and connector 308 may be enclosed in an enclosure and operates the EVSE 302 that is plugged into it. The output from this enclosure (with modified CP) is coupled to the EV.

The CP manipulator 306 monitors characteristics of the AC power (e.g., frequency, voltage and/or current) and manipulates the CP signal provided by the EVSE 302 to produce a modified CP signal. The manipulation alters the duty cycle of the CP signal based on grid stability. If the grid is moving toward being unstable, the modified CP signal reduces the maximum current drawn by the EV (e.g., reduces the duty cycle). The AC power and modified CP are coupled through a J1772 connector (or other suitable connector) to an EV.

FIG. 4 depicts a detailed block diagram of the EVSE 112 of FIGS. 1 and 2 in accordance with at least one embodiment of the invention. The EVSE 112 comprises charging circuitry 204 coupled to the charging controller 206. The charging circuitry 204 receives the AC input 202 comprising L₁, L₂, and ground (G). The charging circuitry 204 comprises conventional voltage, current, and frequency sensors 400 such that the charging controller can monitor the AC voltage, current and/or frequency passing through the charging circuitry 204. The charging circuitry 204 further comprises relays 402 such that the charging controller may control when EV charging begins (close the relays) and when charging ends (open the relays) based on commands from the charging controller 206.

The charging controller 206 comprises at least one processor 406, support circuits 408 and memory 410. The at least one processor 406 may be any form of processor or combination of processors including, but not limited to, central processing units, microprocessors, microcontrollers, field programmable gate arrays, graphics processing units, and the like. The support circuits 408 may comprise well-known circuits and devices facilitating functionality of the processor(s) and its control of the charging circuitry 204. The charging controller 206 may or may not contain safety specified certified circuit boards. The support circuits 408 may comprise one or more of, or a combination of, power supplies, clock circuits, communications circuits, cache, relay drivers, voltage, current, and frequency measurement circuits, filters, and/or the like.

The memory 410 comprises one or more forms of non-transitory computer readable media including one or more of, or any combination of, read-only memory or random-access memory. In some embodiments, the memory 410 may be embedded within the processor 406. The memory 410 stores software and data including, for example, charging control software 412, CP generator software 414 and CP manipulator software 416. The charging control software 410 comprises instructions that ensure an EV is correctly connected to the J1772 connector (or other suitable connector) and controls the charging start and stop time by manipulating the relays 402. The CP generator software 414 and CP manipulator software 416 comprise instructions that, when executed by the at least one processor 406, analyze the voltage, current, and/or frequency measurements to derive the state of grid stability, generate a CP signal and modify the CP signal in view of the grid stability state. In some embodiments, the modified CP signal is directly generated based on the state without generating the traditional CP signal. In other embodiments where the CP manipulator is a stand-alone component or device (e.g., FIG. 3), the CP is first generated by the traditional EVSE and then modified based on the grid stability state. The EVSE 112 outputs, through a J1772 connector 200 (or other suitable connector), the AC power and the modified CP.

FIG. 5 depicts flow diagram of a method 500 of operation of the EVSE in accordance with at least one embodiment of the invention. The method 500 begins at 502 and proceeds to 504, where the method 500 analyzes the AC input measurements of voltage, current and frequency. The analysis produces an at least one indicium of grid stability. In one embodiment, the at least one indicium may be a numerical value that varies with grid stability (e.g., 1 for poor stability, 10 for good stability). In an alternative embodiment, the at least one indicium may be a differential of frequency with respect to time. At 506, the method 500 determines a CP duty cycle that is based on the EVSE rated power which establishes a value of modified CP duty cycle (and maximum current) that cannot be exceeded. At 508, the method 500 manipulates the CP signal from 506 to generate a modified CP signal (e.g., a modified duty cycle that is less than or equal to the initial CP duty cycle). This modified CP signal is directly proportional to the maximum power that can be supplied by a source, e.g., solar, wind turbine, etc. In some embodiments, the method 500 bypasses 506 along path 516 to directly derive the modified CP at 508.

The method 500 uses the grid stability state to derive the CP duty cycle. If the state indicates the grid is very stable, then the method 500 uses the maximum duty cycle allowed by the EVSE charging capabilities to allow the EV to draw maximum current, e.g., 80 Amps. On the other hand, if the grid stability is poor, the modified CP may be adjusted to a lower duty cycle (e.g., 10%) such that the EV draws a lower amount of current, e.g., 6 Amps. Grid stability is a function of a number of factors such as, but not limited to, amount of energy being produced by the renewable resources, amount of power being consumed by loads, amount of energy available from storage, whether the system is connected to the grid, and the like.

In other embodiments, the modified CP signal may be generated to facilitate so-called “green charging”, where the amount of power used to charge the EV is equal to or less than the amount of renewable resource power being generated (i.e., no utility grid power is used to charge the EV). As such, the CP manipulator generates appropriate CP duty cycle based on the amount of power that is available from the renewable resource. The CP manipulator then sets the CP duty cycle to match the available renewable resource power such that, the EV draws only power equal to the level available from the renewable resource.

At 510, the method outputs the modified CP to the EV connector (e.g., J1772 or NACS/Tesla/Type C connector). At 512, the method queries whether the process is to continue such that the CP is continuously and automatically adjusted to changing grid stability. If the query is affirmatively answered, the method 500 proceeds along path 518 to analyze additional AC input measurements. If the grid stability (or the renewable resource power availability) has changed, the method 500 automatically changes the CP to match the grid state or renewable resource power availability. As such, even as the grid stability is deteriorating, the EV will receive some amount of charge and not cause the grid to become unstable or fail. The entire process of grid stability verification to CP Manipulation needs to occur within 1-2 AC cycles. In other embodiments that support green charging, the CP signal is modified to match the variations in renewable resource power generation. If the query at 512 is negatively answered, the method 500 proceeds to 514 and ends.

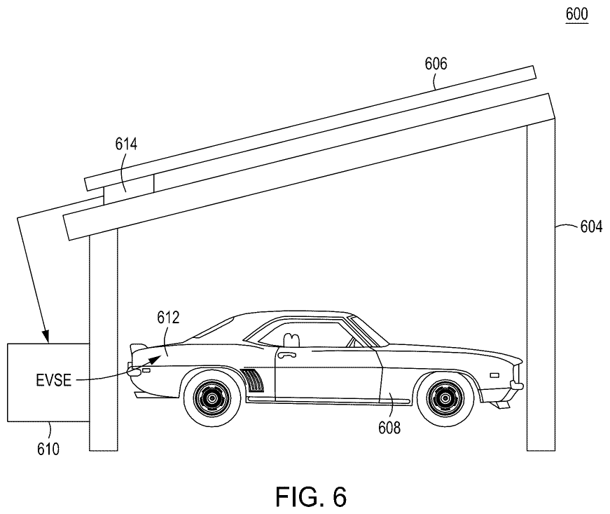

FIG. 6 depicts a solar powered carport scenario 600 for charging an EV in accordance with at least one embodiment of the invention. Embodiments of the invention lend themselves to off-grid EV charging scenarios. Since the EVSE of the present invention, automatically adapts the charging level to the grid stability and/or available renewable resource power availability. The EVSE 610 can be used in off-grid scenarios without causing microgrid failure. In the embodiment of FIG. 6, a carport 604 is outfitted with a plurality of rooftop solar panels 606 and commensurate inverters 614 that are connected directly to the EVSE 610. The EVSE 610 is connected an EV 608. As describe above, the AC power from the renewable resource is coupled through the EVSE 610 to the EV 608 via connector 612. The EVSE 610 manipulates the CP to establish a maximum charging current that will not overload the microgrid created by the inverters 614 and cause the grid to fail. As the amount of energy varies through the day, the EVSE 610 monitors grid stability and adjusts the maximum current being drawn by the EV 608 to match the available power and maintain a stable grid. In this manner, off-grid, no storage, EVSE charging is provided.

In other scenarios, storage (e.g., battery(ies) coupled to one or more inverters) may be added and the EVSE maintains grid stability as energy is consumed from storage at night and used to charge the storage during the day.

In other scenarios, a full renewable energy system, as shown in FIG. 1, may be used and the EVSE may use the CP manipulator only when the system is in an off-grid mode such that power to the EV is adjusted as energy is produced and stored without a grid connection. When the utility grid is reconnected, the traditional CP signal may be used to set the maximum EV charging current.

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

1. Apparatus for adjusting a control pilot signal in electric vehicle supply equipment (EVSE) comprising:
a charging controller, coupled to a utility power grid or microgrid, for measuring grid stability and creating at least one indicium of grid stability; and
a control pilot manipulator for adjusting a duty cycle of the control pilot signal based on the at least one indicium of grid stability.

2. The apparatus of claim 1 wherein the control pilot signal is a square wave and the control pilot manipulator adjusts a duty cycle of the square wave.

3. The apparatus of claim 1 wherein the control pilot signal indicates a maximum amount of current an electric vehicle is able to draw during charging of the electric vehicle.

4. The apparatus of claim 1 wherein the charging controller monitors at least one of the voltage, current and/or frequency of AC power from the utility power grid or microgrid to create the at least one indicium of grid stability.

5. The apparatus of claim 1 further comprising charging circuitry for applying AC power to an electric vehicle.

6. Apparatus for charging an electric vehicle comprising:
electric vehicle supply equipment (EVSE), coupled to a utility power grid or microgrid, configured to supply AC power and a control pilot signal; and
a control pilot signal manipulator, coupled to the EVSE, for determining at least one indicium of grid stability and adjusting a duty cycle of the control pilot signal based on the at least one indicium of grid stability.

7. The apparatus of claim 6 wherein the control pilot signal is a square wave and the control pilot manipulator adjusts a duty cycle of the square wave.

8. The apparatus of claim 7 wherein the control pilot signal indicates a maximum amount of current an electric vehicle is able to draw during charging of the electric vehicle.

9. The apparatus of claim 7 wherein the charging controller monitors at least one of the voltage, current and/or frequency of AC power to create the at least one indicium of grid stability.

10. The apparatus of claim 7 further comprising charging circuitry for applying AC power to an electric vehicle.

11. A method for adjusting a control pilot signal in electric vehicle supply equipment comprising:
measuring grid stability of a utility power grid or microgrid;
creating at least one indicium of grid stability; and
adjusting a duty cycle of the control pilot signal based on the at least one indicium of grid stability.

12. The method of claim 11 wherein the control pilot signal is a square wave and adjusting controls a duty cycle of the square wave.

13. The method of claim 11 wherein the control pilot signal indicates a maximum amount of current an electric vehicle is able to draw during charging of the electric vehicle.

14. The method of claim 11 wherein measuring monitors at least one of the voltage, current and/or frequency of AC power from the utility power grid or microgrid to create the at least one indicium of grid stability.

15. The method of claim 11 further comprising applying AC power to an electric vehicle at a maximum current amount defined by the duty cycle of the control pilot signal.

16. The method of claim 11 wherein adjusting the duty cycle of the control pilot signal occurs only when the grid is a microgrid.

17. The method of claim 11 further comprising:
supplying AC power and a control pilot signal from electric vehicle supply equipment (EVSE) that is coupled to the utility power grid or microgrid; and
determining the at least one indicium of grid stability from the AC power;
adjusting the duty cycle of the control pilot signal based on the at least one indicium of grid stability; and
applying the AC power and the control pilot signal with the adjusted duty cycle to an electric vehicle.

18. The method of claim 17 wherein the control pilot signal is a square wave and the control pilot manipulator adjusts a duty cycle of the square wave.

19. The method of claim 17 wherein the control pilot signal indicates a maximum amount of current the electric vehicle is able to draw during charging of the electric vehicle.

20. The method of claim 17 wherein determining monitors at least one of the voltage, current and/or frequency of AC power from the utility power grid or microgrid to create the at least one indicium of grid stability.
